(19) United States
(12) Patent Application Publication
(10) Pub. No.: US 2011/0156359 A1
(43) Pub. Date: Jun. 30, 2011

(54) TURBINE ENGINE SEALS

(75) Inventors: Xiaoqing Zheng, Niskayuna, NY (US); Xiaoqiang Zeng, Albany, NY (US)

(73) Assignee: General Electric Company

(21) Appl. No.: 12/650,938

(22) Filed: Dec. 31, 2009

(51) Int. Cl. F16J 15/447

(52) U.S. Cl. 277/418

(57) ABSTRACT

A seal in a turbine engine for preventing axial leakage through a radial gap between a stationary structure and a rotating structure, wherein the radial gap is defined by an inner radial surface that opposes an outer radial surface across the radial gap, the seal including: a first groove disposed on one of the inner radial surface and the outer radial surface; and a first tooth that projects radially from the other of the inner radial surface and the outer radial surface; wherein the first groove, at an upstream end, comprises a gradual slope that slopes away from the surface on which the first tooth is located and, at a downstream end, comprises a steep slope; and wherein the first tooth comprises an axial position that is approximately just upstream of the axial position of the upstream end of the groove.

### BACKGROUND OF THE INVENTION

The present application relates generally to systems and apparatus for improving the efficiency and operation of turbine engines, which, as used here and unless specifically stated otherwise, is meant to include all types of turbine or rotary engines, including steam turbine engines, combustion turbine engines, aircraft engines, power generation engines, and others. More specifically, but not by way of limitation, the present application relates to systems and apparatus pertaining to seals for turbine engines and, specifically, to minimizing leakage flow between stationary and rotating parts of a turbine engine.

In many turbine engines, labyrinth seals are often used as a means of minimizing the leakage of working fluid between stationary and rotating parts. These stationary and rotating parts are generally radial in shape. In general, these seals include, on either the stationary or rotating part, multiple axially spaced teeth that are either machined integrally with, or inserted into the radial surface. Typically, the opposing radial surface is machined to provide axially spaced, protruding annular lands that, along with the radial surfaces between the lands, are regarded as part of the sealing assembly. The gap between the teeth and the high and low parts of the lands is called a “clearance” and maintaining minimal clearance is essential in minimizing the leakage of working fluid, which improves the efficiency of the engine.

However, operational transient conditions, which, for example, may include engine startup, shutdown, or load swings, often result in axial movement of the rotating parts in relation to stationary parts, which may cause the teeth or other structures that define the labyrinth seal on one radial surface to contact or collide with the teeth or structures on the opposing radial surface. This contact typically results in the wear of the teeth and the profiles of the radial surfaces. Such damage may result in a compromised seal and an increase in working fluid leakage.

Conventional steam turbine design practice generally requires a tradeoff between, on the one hand, providing effective sealing and, on the other, ensuring minimal damage to the seal, as will be described later in this disclosure. Existing seals may provide effective sealing, but their design results in subsequent damage to the seal due to axial movement of the rotor. Alternatively, other conventional seals prevent such damage, but require wide clearances that do a poor job of sealing the flow of working fluid through the gap.

As a result, there remains a need for improved sealing systems and apparatus that provide a high level of sealing performance while minimizing the wear and tear of the seal during certain operating conditions.

### BRIEF DESCRIPTION OF THE INVENTION

The present application thus describes a seal in a turbine engine for preventing axial leakage through a radial gap between a stationary structure and a rotating structure, wherein the radial gap is defined by an inner radial surface that opposes an outer radial surface across the radial gap, the seal including: a first groove disposed on one of the inner radial surface and the outer radial surface; and a first tooth that projects radially from the other of the inner radial surface and the outer radial surface; wherein the first groove, at an upstream end, comprises a gradual slope that slopes away from the surface on which the first tooth is located and, at a downstream end, comprises a steep slope; and wherein the first tooth comprises an axial position that is approximately just upstream of the axial position of the upstream end of the groove.

These and other features of the present application will become apparent upon review of the following detailed description of the preferred embodiments when taken in conjunction with the drawings and the appended claims.

### BRIEF DESCRIPTION OF THE DRAWINGS

These and other features of this invention will be more completely understood and appreciated by careful study of the following more detailed description of exemplary embodiments of the invention taken in conjunction with the accompanying drawings, in which:

FIG. 1 illustrates a conventional hi-lo seal;

FIG. 2 depicts an alternate conventional seal, which is commonly referred to as an interlocking seal;

FIG. 3 illustrates another conventional seal that may be used in a turbine engine;

FIG. 4 illustrates a seal according to an exemplary embodiment of the present application that may be used in, for example, turbine engine applications;

FIG. 5 depicts a fluid flow pattern for the seal illustrated in FIG. 4;

FIG. 6 assists in describing the preferred dimensions of the various parts of an exemplary seal according to the present application;

FIG. 7 illustrates an alternative embodiment of the present invention, together with a flow pattern generated by a flow of working fluid from left to right in the figure; and

FIG. 8 illustrates another seal in accordance with an exemplary embodiment of the present application.

### DETAILED DESCRIPTION OF THE INVENTION

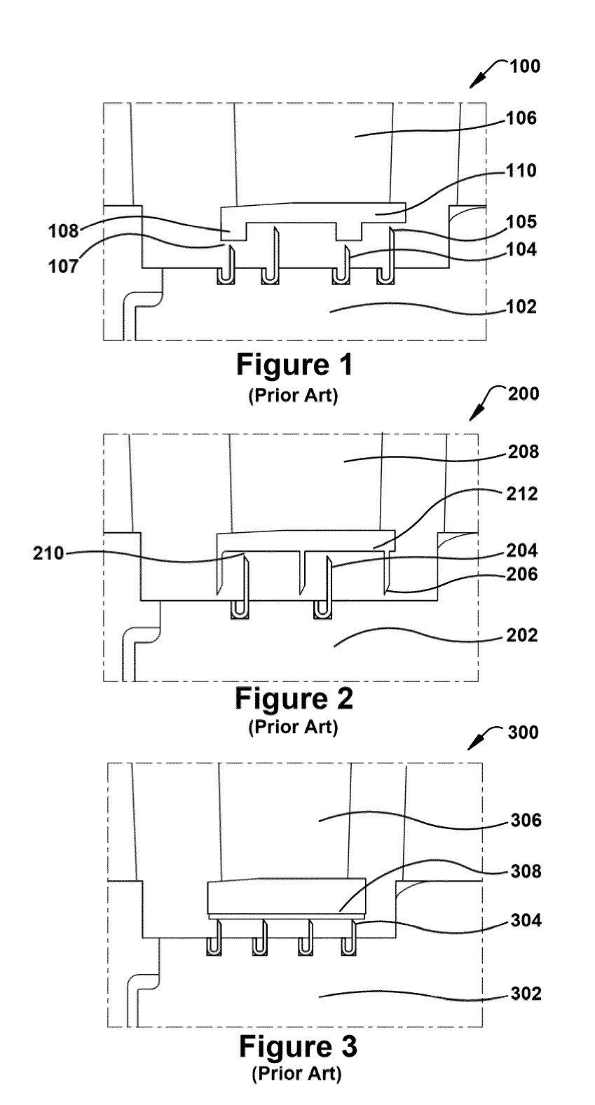

The following detailed description is made with reference to the figures. FIGS. 1, 2, and 3 illustrate seals that are commonly used in turbine engines, which are known in the art. Subsequently, exemplary embodiments of the present invention are described.

To describe clearly the invention of the current application, it may be necessary to select terminology that refers to and describes certain machine components or parts of a turbine engine. Whenever possible, common industry terminology will be used and employed in a manner consistent with its accepted meaning. However, it is meant that any such terminology be given a broad meaning and not narrowly construed such that the meaning intended herein and the scope of the appended claims is unreasonably restricted. Those of ordinary skill in the art will appreciate that often certain components may be referred to with several different names. In addition, what may be described herein as a single part may include and be referenced in another context as consisting of several component parts, or, what may be described herein as including multiple component parts may be fashioned into and, in some cases, referred to as a single part. As such, in understanding the scope of the invention described herein, attention should not only be paid to the terminology and description provided, but also to the structure, configuration, function, and/or usage of the component as described herein.

In addition, several descriptive terms may be used herein. The meaning for these terms shall include the following definitions. As used herein, “downstream” and “upstream” are terms that indicate a direction relative to the flow of working fluid through the turbine. As such, the term “downstream” means the direction of the flow, and the term “upstream” means in the opposite direction of the flow through the turbine. Related to these terms, the terms “aft” and/or “trailing edge” refer to the downstream direction, the downstream end and/or in the direction of the downstream end of the component being described. And, the terms “forward” or “leading edge” refer to the upstream direction, the upstream end and/or in the direction of the upstream end of the component being described. The term “radial” refers to movement or position perpendicular to an axis. It is often required to describe parts that are at differing radial positions with regard to an axis. In this case, if a first component resides closer to the axis than a second component, it may be stated herein that the first component is “inboard” or “radially inward” of the second component. If, on the other hand, the first component resides further from the axis than the second component, it may be stated herein that the first component is “outboard” or “radially outward” of the second component. The term “axial” refers to movement or position parallel to an axis. And, the term “circumferential” refers to movement or position around an axis. The term “nozzle” in a steam turbine refers to the same structure as “stator” in a gas turbine and a jet engine.

Referring now to the figures, FIG. 1 illustrates a conventional hi-lo seal 100, which attempts to provide a convoluted path to leaking fluid flowing downstream from left to right in the FIG. 1. Hi-lo is a type of labyrinth seal with teeth of alternating height (hi-lo). This arrangement allows for close clearances between the teeth and the grooves on the opposing surface of the seal. A labyrinth seal functions by placing a relatively large number of barriers, such as teeth, to the flow of fluid from a high pressure region to a low pressure region on opposite sides of the seal, with each barrier forcing the fluid to follow a tortuous path, creating a pressure drop. The hi-lo seal 100 exists between a rotor 102 with axially-spaced short teeth 104 and long teeth 105, which may be sharp sealing teeth or j-seals, and a nozzle (or stator) 106. The short teeth 104 and the long teeth 105, protruding from the inner radial surface of the rotor 102 toward the inner radial surface of the nozzle 106, have a “hi-b” design with close clearances 107 between the short teeth 104 and raised lands (or hi lands) 108, and between the long teeth 105 and the surfaces 110. The hi-lo seal 100 thus provides a relatively large number of barriers (such as the short teeth 104, the long teeth 105, and the raised lands 108) to the flow of fluid from a high pressure region (left side of FIG. 1) to a low pressure region (right side of FIG. 1) on opposite sides of the hi-lo seal 100. Because of the hi-lo design, the fluid is forced to flow through a tortuous path, creating a pressure drop across the hi-lo seal 100. As already discussed, operational transient conditions of turbine engines during startup, shutdown, load swings, and so on, often result in axial movement of the rotating part and possible contact or striking of the raised lands 108 by the long teeth 105. This action can result in considerable damage to the hi-lo seal 100 and a reduction its ability to prevent leakage flow in a turbine.

FIG. 2 depicts an alternate conventional seal, commonly referred to as an interlocking seal 200. As illustrated, a rotor 202 with teeth 204 may be closely fitted with raised lands 206, projecting from a nozzle (or stator) 208. The raised lands 206 are essentially teeth, designed to interlock with the teeth 204 projecting from the rotor 202. The rotor 202 and the nozzle 208 are constructed to include a constant clearance 210 between the teeth 204 and surfaces 212 between the raised lands 206. Although this interlocking seal 200 provides a drawn-out path for the fluid flow, the interlocking seal 200 remains vulnerable to damage due to axial movement of the rotor 202. The axial movement of the rotor 202 may be limited by the distance between the teeth 204 and teeth 206.

FIG. 3 illustrates another conventional turbine engine seal 300, showing a rotor 302 with projecting teeth 304. A nozzle (or stator) 306 has a flat surface 308, which may preclude damage to the conventional turbine engine seal 300 due to axial movement. This conventional turbine engine seal 300, however, may not provide satisfactory sealing, as the fluid flowing downstream, from left to right, has a fairly guided and straightforward path.

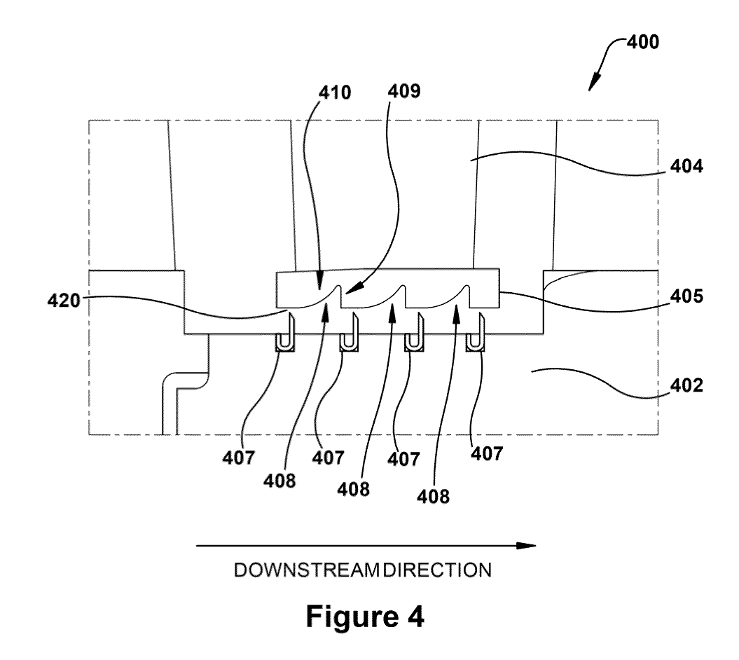

Referring now to FIG. 4, a seal 400 for a turbine or rotary engine according to an exemplary embodiment of the present application is illustrated. In some embodiments, the seal 400 may be employed in a gap between a stationary structure and a rotating structure of a turbine engine. As will be described, the seal 400 may provide an effective seal that discourages the flow or leakage of working fluid through the gap while also allowing axial movement between the rotating and stationary structures that does not result in damage to the seal. That is, as shown in the several figures and discussed in more detail below, in some embodiments, the structures of the seal 400 that oppose each other across the gap do not overlap radially, which allows the parts to move axially without risking seal damaging contact. In some embodiments, the stationary structure or part may be a steam turbine nozzle inner cover, gas turbine stator inner support, or simply a packing ring, as well as other stationary structures. Further, in some embodiments, the rotating structure or part may be a rotor, a shaft, or a disk or a drum connected to a rotor, as well as other rotating structures. In the present embodiment, the seal 400 is positioned between a rotating structure, which is a rotor 402, and a stationary structure, which is a nozzle 404. As already mentioned, the scope of the claimed invention includes all types of combustion turbine or rotary engines, including steam turbine engines, gas turbine engines, aircraft engines, power generation engines, and others.

Returning to FIG. 4, the rotor 402 may have a radial surface facing the radial surface of the nozzle 404. The rotor 402 may include a number of teeth 407 protruding from its surface, and the nozzle 404 has an inner cover 405 bearing a number of grooves 408.

At an upstream end of the nozzle 404, a first groove 408 may be machined into the radial surface of the nozzle inner cover 405. At an upstream end of the rotor 402, a first tooth 407 may project radially from the radial surface of the rotor 402 toward the nozzle inner cover 405. The downstream direction of fluid flow is from left to right, as indicated in FIG. 4. As illustrated, a downstream end of the first groove 408 may include a steep slope 409 that, when moving in the downstream direction, slopes toward the rotor 402, while an upstream end of the first groove 408 may have a substantially convex, gradual slope 410 that, when moving in the downstream direction, slopes away from the rotor 402. The steep slope 409 at the downstream end of the first groove 408 may meet the end of the gradual slope 410 in a concave arc, thereby forming the first groove 408 according to an exemplary embodiment of the present application. In the present exemplary embodiment, the gradual slope 410 of the upstream end of the first groove 408 may form a smooth, curved contour, as illustrated in FIG. 4. It should be noted that in alternate embodiments, the gradual slope 410 on one or more of the grooves 408 may have a linear or flat contour instead of a curved one. The axial position of the first tooth 407 may lie just upstream of the axial position of the upstream end of the first groove 408.

Moving in the downstream direction from the first groove 408, the seal 400 may include a second tooth 407 that extends radially from the rotor 402 towards the nozzle 404. The second tooth 407 may occupy an axial position just downstream of the axial position of the downstream end of the first groove 408. A second groove 408 may also be provided, such that an upstream end of the second groove 408 may be axially positioned approximately just downstream of the axial position of the second tooth 407.

In the present embodiment, the upstream end of the second groove 408 may include a gradual slope 410 that slopes away from the radial surface of the rotor 402 and a downstream end of the second groove 408 may bear a steep slope 409, similar to that described above in relation to the first groove 408. The steep slope 409 may meet the gradual slope 410 in a smooth concave arc, thus forming the second groove 408. A third tooth 407, projecting radially from the rotor 402 surface, may reside at an axial position that is approximately just downstream of the axial position of the downstream end of the second groove 408. In some embodiments, a third groove 408 may be present, such that an upstream end of the third groove 408 is positioned approximately just downstream of the axial position of the third tooth 407. Here, similar to that of the first and second grooves 408, the upstream end of the third groove 408 may exhibit a gradual slope 410, sloping away from the radial surface of the rotor 402. A downstream end of the third groove 408 may include a steep slope 409, where it may join the gradual slope 410 at the upstream end of the third groove 408 to form the third groove 408. In some embodiments, a fourth tooth 407 may project radially from the rotor 402 at an axial position that is just downstream of the axial position of the downstream end of the third groove 408. All teeth 407 in the seal 400 may extend radially toward the opposing radial surface such that each tooth 407 terminates at a position that is relatively close in proximity to the opposing surface. In FIG. 4, this relatively small distance is referred to as a clearance 420.

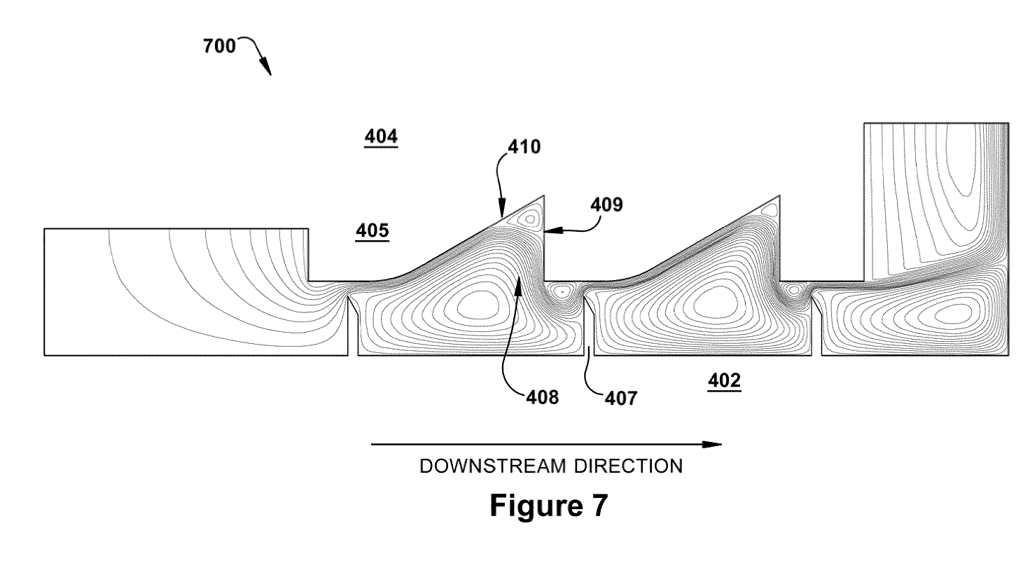

Although the present embodiment describes the teeth 407 being disposed on the rotating surface (the rotor 402 in the embodiment of FIG. 4) and the grooves 408 on the stationary surface (the nozzle 404 in the embodiment of FIG. 4), it is possible, in alternate embodiments, including those embodiments set forth in FIGS. 4 and 7, for the rotating surface to bear the grooves 408 and for the teeth 407 to be fixed on the stationary surface. As shown in FIG. 4, the teeth 407 may be fixed on an inner radial surface, while an opposing outer radial surface bears the grooves 408. Alternatively, though not shown in the figures, other embodiments may include the teeth 407 projecting from an outer radial surface (whether this surface is rotating or stationary) and the grooves 408 being present on an opposing inner radial surface (whether this surface is rotating or stationary).

In general, as already stated, the non-contact seal structure of FIG. 4 allows free axial movement of the rotor 402 while preventing damage to the seal 400 that often results from the axial movement of the opposing structures during transient operating conditions. Moreover, the structure of the seal 400 provides effective sealing as it creates a flow path that discourages the leakage of working fluid, as discussed directly below.

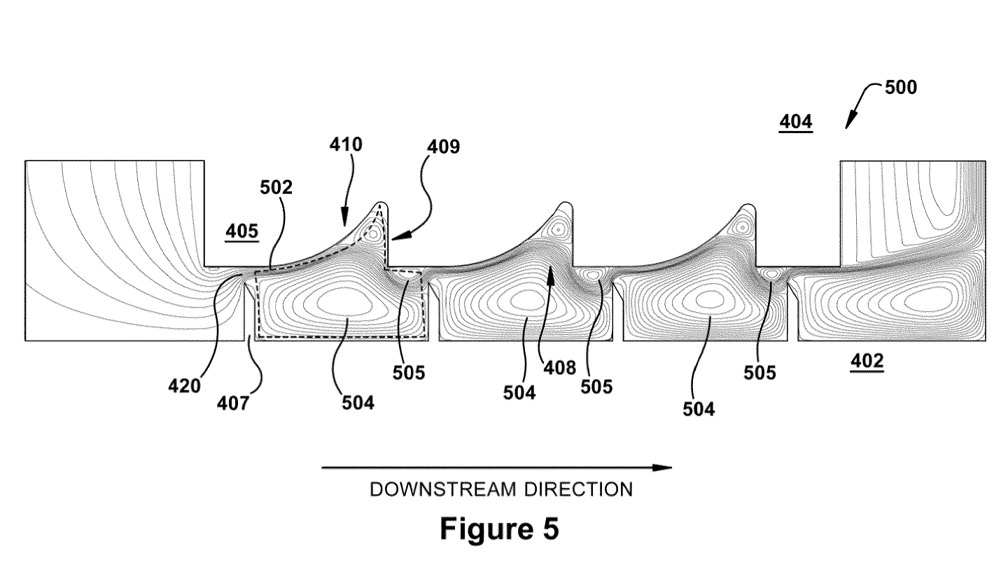

FIG. 5 depicts a fluid flow pattern 500 for the seal 400 illustrated in FIG. 4. The depicted nozzle 404 bears the grooves 408, which form the profile discussed in connection with FIG. 4 and the teeth 407 protrude from the rotor 402. It has been discovered that, in operation, the leakage fluid that flows downstream through the clearance 420 of the first tooth 407 generally follows the gradual slope 410 of the upstream portion of the groove 408, shown in FIG. 5. In general, the seal 400 may provide non-contact sealing action by controlling the passage of fluid through a variety of chambers (such as chamber 502 shown in dotted lines), resulting in a recirculation motion and the formation of controlled fluid vortices 504. The recirculation motion forces the fluid outwards, such that the fluid follows the curved profile of the nozzle 404 to a sudden stop at the steep slope 409. The groove 408 profile and the chamber's 502 aspect ratio are set, such that the fluid flow follows the curved profile of the grooves 408 closely in order to create an overshoot phenomenon, as described in the subsequent discussion.

Nearing the downstream end of the first groove 408, the fluid encounters a steep barrier, i.e., the steep slope 409 at the downstream end of the first groove 408. This obstacle forces the fluid to flow in an inwardly radial direction. Given this direction of flow, once the fluid exits the confines of the groove 408, the fluid generally overshoots the clearance 420 defined by the tooth 407 that is directly downstream of the groove 408. That is, because of the flow direction imparted to the fluid by the steep slope 409 at the downstream end of the first groove 408, the fluid (or a significant percentage thereof) misses the gap that affords it downstream progress. Without any guidance, the fluid flow changes direction towards the clearance 420 between the teeth 407 and the opposing nozzle inner cover 405 surface. Small, but strong, vortices 505 form just upstream of the clearances 420. The vortices 505 substantially block a direct fluid leaking path. As such, the seal 400 achieves highly effective sealing properties without having some of the shortcomings of other conventional seals. Further, there is no possibility of damage to the seal 400 from axial movement of the rotor 402. The fluid flow pattern 500 is meant to be exemplary, and naturally, in other configurations of the invention, such as a seal with a greater number of grooves and teeth or one having differently shaped grooves or teeth, the flow pattern would change. The various embodiments of the invention, however, will provide a sufficiently complicated path to the fluid, ensuring high-quality sealing.

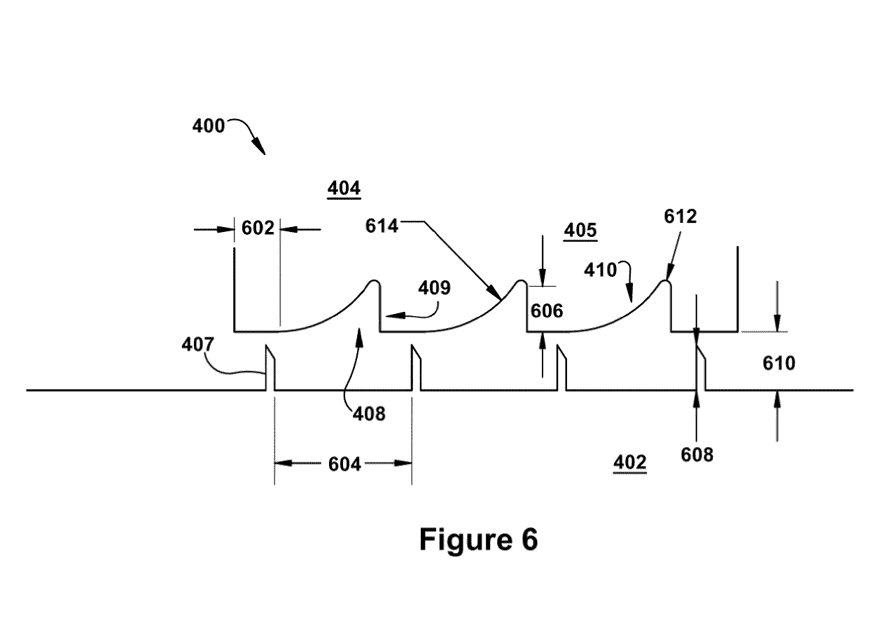

It has been discovered through experimentation and computer modeling of flow patterns that certain dimensions and certain ratios pertaining to the dimensions are more effective at sealing than others. FIG. 6 assists in describing the exemplary dimensions of the various parts of the seal 400, which, as described, includes three grooves 408 and four teeth 407. In other implementations, variations in certain structural features of the seal 400 (such as the number of grooves and teeth, the shape of the grooves, or the axial position of the grooves relative to the axial position of the teeth), are only limited by the scope as defined by the claims. In some embodiments, the width of a flat portion 602 approximately just upstream of the gradual slope 410 of the groove 408 may be between approximately 0.05 and 0.15 inches. More preferably, the width of the flat portion 602 approximately just upstream of the gradual slope 410 of the groove 408 may be about 0.110 inches, making the seal 400 compact.

In some embodiments, the axial length 604 between two consecutive teeth 407 may be between approximately 0.2 and 0.4 inches. More preferably, the axial length 604 between two consecutive, teeth 407 may be approximately 0.328 inches. In some embodiments, the radial depth 606 of the groove 408 may be between approximately 0.05 and 0.2 inches. More preferably, the radial depth 606 of the groove 408 may be around 0.106 inches. In some embodiments, the radial height 608 of the tooth 407 may be between approximately 0.05 and 0.2 inches. More preferably, the radial height 608 of the tooth 407 may be approximately 0.110 inches. In some embodiments, the radial distance across a radial gap 610 may be between approximately 0.05 and 0.2 inches. More preferably, the radial distance across a radial gap 610 may be around 0.140 inches. Further, the radius of a small arc 612 just upstream of the steep slope 409 of the groove 408 may be approximately 0.015 inches, and the radius of an arc 614 defined by the gradual slope 410 of the groove 408 may be approximately 0.250 inches.

In addition, as stated, it has been discovered through experimentation and computer modeling of flow patterns that certain ratios pertaining to certain dimensions are more effective at sealing than others. A ratio X, defined by the radial depth 606 of the groove 408 divided by the radial distance across a radial gap 610, may lie in the range between approximately 0.3 and 0.5. Another ratio Y, defined by the radial distance across a radial gap 610 divided by the axial length 604 between two consecutive teeth 407, may lie in the range between approximately 0.25 and 0.5. The ratio Z of the radial height 608 of the tooth 407 to the axial length 604 between two consecutive teeth 407 may fall in the range between approximately 0.25 and 0.5. A ratio W falls in the range between approximately 0.75 and 0.9, being defined by the radial height 608 of the tooth 407 divided by the radial distance across a radial gap 610.

Another set of dimensions may be defined for the seal 400, set out as follows. An angle Θ1, generally formed between the gradual slope 410 of the upstream end of the groove 408 and an axially aligned reference line, can lie in the ranges between approximately 15 and 65 degrees or approximately 25 and 55⁻ degrees, or it can be approximately 35 degrees. Further, an angle Θ2 formed generally between the steep slope 409 of the downstream end of the groove 408 and an axially aligned reference line can be approximately 90 degrees or can fall in the ranges between approximately 70 and 110 degrees or approximately 80 and 100 degrees.

It should be understood that the value of a dimension for one element may not apply to other similar elements of the seal 400. For example, a dimension, such as the angle Θ1, may vary from one groove 408 in the seal 400 to another. The above dimensions are provided as examples of preferred embodiments having effective overall sealing properties. It should be appreciated that some dimensions can be made larger to have a better local sealing effect, but that, in turn, may increase the size of the interval between the teeth and reduce number of teeth that may fit into a given space, which may negatively effect performance.

So far, seals having four teeth and three grooves have been described in this disclosure. The number of teeth and grooves may, however, vary depending on the specific seal size or other requirements related to the sealing.

FIG. 7 illustrates an alternative embodiment of the present invention, a 3-teeth seal 700, together with a flow pattern generated by a flow of steam from left to right in FIG. 7. Here, the 3-teeth seal 700 may have two grooves 408 on the nozzle 404 opposing the rotor 402, which may bear three teeth 407, forming a smaller seal that may be required in certain applications due to space constraints. In contrast to the exemplary embodiment of FIG. 4, this embodiment may include a gradual slope 410 that is straight or linear at the upstream ends of the grooves 408, as opposed to the arcs defined by the upstream ends of the grooves 408 in the seal 400, illustrated in FIG. 4. The upstream ends of the grooves 408 may include a gradual slope 410 that slopes away from the surface of the rotor 402, and at the downstream ends, the grooves 408 may bear a steep slope 409.

As can be seen from FIG. 7, two of the teeth 407 may be situated at the upstream end of the 3-teeth seal 700, with each of the two teeth 407 lying approximately just upstream of the axial position of the upstream end of one of the grooves 408, as shown. One of the teeth 407 may lie at the downstream end of the 3-teeth seal 700. This tooth 407 may occupy an axial position that is approximately just downstream of the axial position of the downstream end of one of the grooves 408, which is situated at the downstream end of the 3-teeth seal 700.

Similar to that shown in FIG. 5, the 3-teeth seal 700 of FIG. 7 provides a seal structure that forces the fluid to follow a path that discourages leakage. Moreover, in the event of substantial axial movement, there can be no collisions between the teeth 407 and the opposing surface, preventing seal impairment.

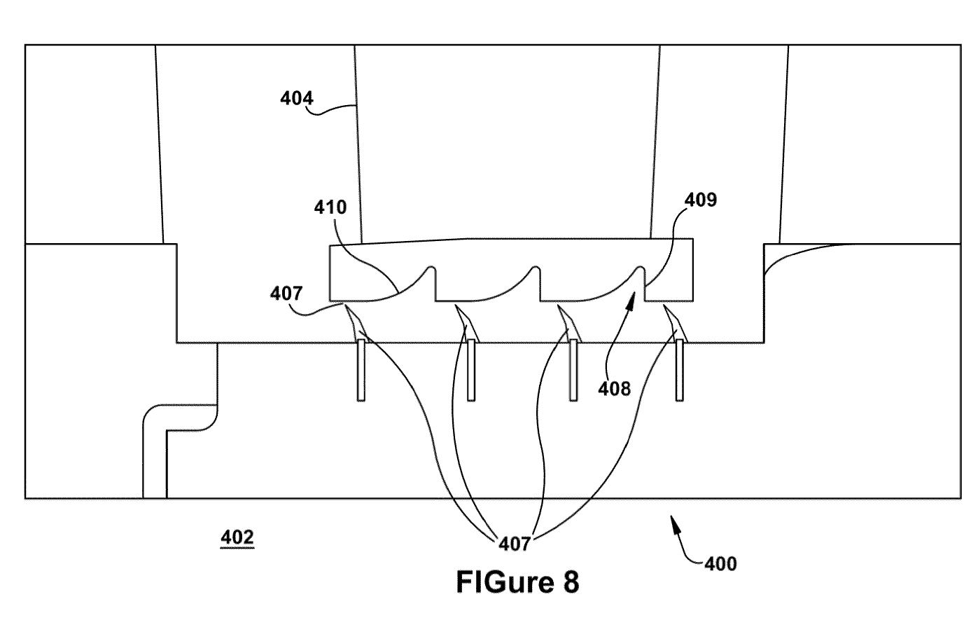

Another embodiment of the present application is illustrated in FIG. 8. In the other embodiments described herein, the teeth have been shown having a radial alignment (i.e., such that they are substantially perpendicular to the surface on which they are located). It will be appreciated that the teeth according to the present invention may have be slanted or have a lean and still function as intended. For example, in one preferred embodiment, as shown in FIG. 8, the teeth 407 may lean forward (i.e., in the upstream direction). This alignment may be more effective at preventing leakage, but generally, comes at an increased cost of manufacturing/constructing/installing the teeth. In this type of embodiment, the axial position of the forward point of the leaning teeth may be downstream of the axial position of the rearward edge of the groove 408 it follows.

As one of ordinary skill in the art will appreciate, the many varying features and configurations described above in relation to the several exemplary embodiments may be further selectively applied to form the other possible embodiments of the present invention. For the sake of brevity and taking into account the abilities of one of ordinary skill in the art, all of the possible iterations are not provided or discussed in detail, though all combinations and possible embodiments embraced by the several claims below or otherwise are intended to be part of the instant application. In addition, from the above description of several exemplary embodiments of the invention, those skilled in the art will perceive improvements, changes and modifications. Such improvements, changes and modifications within the skill of the art are also intended to be covered by the appended claims. Further, it should be apparent that the foregoing relates only to the described embodiments of the present application and that numerous changes and modifications may be made herein without departing from the spirit and scope of the application as defined by the following claims and the equivalents thereof.

We claim:

1. A seal in a turbine engine for preventing axial leakage through a radial gap between a stationary structure and a rotating structure, wherein the radial gap is defined by an inner radial surface that opposes an outer radial surface across the radial gap, the seal comprising:
a first groove disposed on one of the inner radial surface and the outer radial surface; and
a first tooth that projects radially from the other of the inner radial surface and the outer radial surface;
wherein the first groove, at an upstream end, comprises a gradual slope that slopes away from the surface on which the first tooth is located and, at a downstream end, comprises a steep slope; and
wherein the first tooth comprises an axial position that is approximately just upstream of the axial position of the upstream end of the groove.

2. The seal according to claim 1, wherein the groove is disposed on the stationary structure and the tooth is disposed on the rotating structure.

3. The seal according to claim 1, wherein the groove is disposed on the rotating structure and the tooth is disposed on the stationary structure.

4. The seal according to claim 1, wherein the groove is disposed on the inner radial surface and the tooth is disposed on the outer radial surface.

5. The seal according to claim 1, wherein the groove is disposed on the outer radial surface and the tooth is disposed on the inner radial surface.

6. The seal according to claim 1, the tooth is an integral part of the other of the inner radial surface and the outer radial surface.

7. The seal according to claim 1, the tooth is inserted and/or caulked into the other of the inner radial surface and the outer radial surface.

8. The seal according to claim 1, further comprising a second tooth that projects radially from the same radial surface as the first tooth;
wherein the second tooth comprises an axial position that is approximately just downstream of the axial position of the downstream end of the first groove.

9. The seal according to claim 1, wherein the first tooth and the second tooth comprise a forward lean, and wherein an axial position of a forward point of the leaning first tooth and the leaning second tooth comprises an axial position that is downstream of an axial position of a rearward edge of the groove it follows.

10. The seal according to claim 8, further comprising a second groove;
wherein the second groove, at an upstream end, comprises a gradual slope that slopes away from the radial surface on which the second tooth is located and, at a downstream end, comprises a steep slope.

11. The seal according to claim 10, further comprising:
a third tooth that projects radially from the same radial surface as the first tooth, wherein the third tooth comprises an axial position that is approximately just downstream of the axial position of the downstream end of the second groove; and
a third groove, wherein the third groove, at an upstream end, comprises a gradual slope that slopes away from the radial surface on which the first tooth is located and, at a downstream end, comprises a steep slope, and wherein the upstream end of the third groove comprises an axial position that is approximately just downstream of the axial position of the third tooth.

12. The seal according to claim 11, further comprising a fourth tooth that projects radially from the same radial surface as the first tooth, wherein the fourth tooth comprises an axial position that is approximately just downstream of the axial position of the downstream end of the third groove.

13. The seal according to claim wherein:
an angle Θ1 is generally formed between the gradual slope of the upstream end of the first groove and an axially aligned reference line; and
the first groove is configured such that angle Θ1 is between approximately 15 and 65 degrees.

14. The seal according to claim 1, wherein:
an angle Θ1 is generally formed between the gradual slope of the upstream end of the first groove and an axially aligned reference line; and
the first groove is configured such that angle Θ1 is between approximately 25 and 55 degrees.

15. The seal according to claim 1, wherein:
an angle Θ1 is generally formed between the gradual slope of the upstream end of the first groove and an axially aligned reference line; and
the first groove is configured such that angle Θ1 is approximately 35 degrees.

16. The seal according to claim 1, wherein:
an angle Θ2 is generally formed between the steep slope of the downstream end of the first groove and an axially aligned reference line; and
the first groove is configured such that angle Θ2 is between approximately 70 and 110 degrees.

17. The seal according to claim 1, wherein:
an angle Θ2 is generally formed between the steep slope of the downstream end of the first groove and an axially aligned reference line; and
the first groove is configured such that angle Θ2 is between approximately 80 and 100 degrees.

18. The seal according to claim 1, wherein:
an angle Θ2 is generally formed between the steep slope of the downstream end of the first groove and an axially aligned reference line; and
the first groove is configured such that angle Θ2 is approximately 90 degrees.

19. The seal according to claim 1, wherein:
the stationary structure comprises one of a steam turbine nozzle inner cover, a stator inner support, and a packing ring; and
the rotating structure comprises one of a rotor, a shaft, and a disk or drum connected to a rotor.

20. The seal according to claim 1 wherein:
the gradual slope of the upstream end of the first groove comprises a smooth, curved contour; and
the first tooth extends radially a distance such that the first tooth terminates in relatively close proximity to the opposing surface.

21. The seal according to claim wherein:
a ratio X is defined by the radial depth of the first groove divided by the radial distance across the radial gap; and
the seal is configured such that the ratio X comprises a range of between approximately 0.3 and 0.5.

22. The seal according to claim 8, wherein:
a ratio Y is defined by the radial distance across the radial gap divided by the axial length between the first tooth and the second tooth; and
the seal is configured such that the ratio Y comprises a range of between approximately 0.25 and 0.5.

23. The seal according to claim 8, wherein:
a ratio Z is defined by the radial height of the first tooth divided by the axial length between the first tooth and the second tooth; and
the seal is configured such that the ratio Z comprises a range of between approximately 0.25 and 0.5.

24. The seal according to claim 8, wherein:
a ratio W is defined by the radial height of the first tooth divided by the radial distance across the radial gap; and
the seal is configured such that the ratio W comprises a range of between approximately 0.75 and 0.9.
